(19) United States
(12) Patent Application Publication
(10) Pub. No.: US 2022/0369600 A1
(43) Pub. Date: Nov. 24, 2022

(54) SYSTEM FOR COLLECTING, MONITORING AND ANALYSING ANIMAL BEHAVIOR

(71) Applicant: ANHANGUERA EDUCACIONAL PARTICIPAÇÕES S/A, Valinhos (BR)

(72) Inventors: Leandro DE JESUS, Aquidauana (BR); Celso CORREIA DE SOUZA, Campo Grande (BR); Marcia FERREIRA CRISTALDO, Aquidauana (BR); Pedro Paulo PIRES, Campo Grande (BR); Quintino IZIDIO DOS SANTOS NETO, Campo Grande (BR)

(73) Assignee: ANHANGUERA EDUCACIONAL PARTICIPAÇÕES S/A, Valinhos (BR)

(21) Appl. No.: 17/770,810

(22) PCT Filed: Oct. 22, 2020
(86) PCT No.: PCT/BR2020/050433

§ 371 Date: Apr. 21, 2022

(30) Foreign Application Priority Data
Oct. 24, 2019 (BR) 10 2019 022304.9

(51) Int. Cl. A01K 29/00

(52) U.S. Cl. CPC A01K 29/005

(57) ABSTRACT

The present invention refers to a system of environmental data collection, monitoring and behavioral analysis of animals on pasture, in a georeferenced environment using agrometeorological sensors, with the objective of spreading precision farming. The data generated is collected over a wireless network and stored in a database. The system is capable of analyzing the data of the various sensors to generate information on the cattle's behavior, and can also correlate them with environmental characteristics and data of the management area.

The present invention refers to a system of environmental data collection, monitoring and behavioral analysis of animals on pasture, in a georeferenced environment using agrometeorological sensors, with the objective of spreading precision farming.

For data collection, collars with sensors in animals are used to generate better and more detailed information, such as increased productivity.

One of the needs for monitoring animals in the field, with precision, is to know in detail the behavior of these individuals, being an analysis factor the way they move. Thus, this invention aims to develop a wireless communication system for data collection regarding the animals' global positioning in the field.

The animals are monitored by means of a collar with sensor. The data generated is collected over a wireless network and stored in a database. The system is capable of analyzing the data of the various sensors to generate information on the cattle's behavior, and can also correlate them with environmental characteristics and data of the management area.

### TECHNICAL STATUS

The symptoms of health and welfare changes in an animal affect its behavior (Godsk & Kjaergaard, 2011). Changes in the standard time spent by the animal in activities such as standing, lying, eating or walking may indicate abnormalities caused by infections, fever and social or environmental stress. These behaviors are generally consistent and predictable, but cannot be measured in scale due to the work required to continuously monitor a large number of animals.

Some companies provide similar solutions, such as Israeli cattle-Watch and Globalstar, however, these solutions are limited to only monitoring the animals, and the specialist must carry out all analyzes regarding the animal's behavior.

In addition to the GPS sensor contained in other solutions, the invention uses sensors that capture the animal's movement, in addition to environmental data (air temperature, air humidity and solar radiation). All these data sources are of extreme importance for the identification of the animal's basic behavior in the field—grazing, ruminating, walking, standing and lying. Based on the frequency with which animals perform these activities and environmental data, it is possible to detect health problems, stress, preference for pastures or even animal performance.

All of these findings are possible by the use of artificial intelligence algorithms.

The patent application AU2017239570 reveals a tracking system for monitoring and controlling animals using a device, comprising: a position detector to determine the animal's location; a stimulator to selectively apply stimulation to the animal; an identification module comprising information related to the animal and a communication processor to detect the animal's position.

Document WO2017096256 describes an animal health monitoring system that includes a multitude of label sets configured to be individually arranged for a population of animals. Each set of labels includes one or more sensors configured to measure individual characteristics of the animal population. The system includes a communication concentrator attached to the animal label assembly and is configured to inform one or more characteristics of the animal from the plurality of animal label sets. The system includes a communication controller attached to the concentrator and configured to receive one or more characteristics of the animal.

Patent Application US20160135431 describes a collar shape device for animals to monitor location, physiological information, and/or environmental information for an animal using this device. The collar may include several sensors and other electrical components embedded in the body of the collar that provide means to track and monitor the activity and whereabouts of an animal, increase the collar visibility, and store and retrieve information about animals, environment and system. The collar can program one or more wired or wireless communication devices so that the collar can transmit data to a connected computing device.

WO2007119070A1 reports a method and system for monitoring cattle condition that comprises a plurality of sensors to detect a plurality of different behavioral parameters of an animal. Data are detected and transmitted by a unit, wireless, to a central processor and a plurality of animal status conditions is determined based on transmitted and detected data, such as set of deliveries, fertility status, and other health status conditions

The documents found do not refer exactly to the object of the invention as it is proposed, because, in addition to presenting animal data and localization, it also presents environmental data and uses improved technologies to generate better results compared to already known technologies.

### DEVICES AND SENSORS

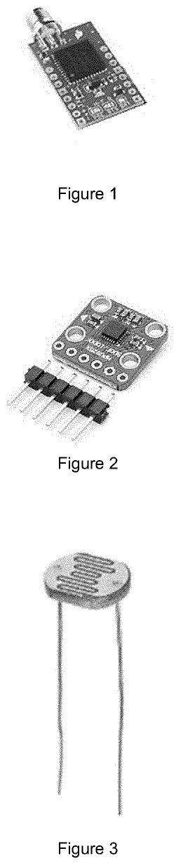

A GPS receiver module was used to collect animal positioning data. The model used is the GPS Venus produced by SparkFun. This is a low-cost, low-power receiver with a minimum input voltage of 3.3 V and a consumption of 2 mA (in idle state) and 6 mA (at maximum recording rate). It is based on the Venus638FLPx chipset, which is programmed by default with a 1 Hz refresh rate (configurable up to 20 Hz) and can be easily integrated into microcontrollers such as Arduino. GPS module: SparkFun Venus GPS with SMA connector. (FIG. 1)

To capture animal motion data, an inertial measuring plate, accelerometer and 9-axis gyroscope 10 DOF MPU-9250 were used, with three sensors: accelerometer, gyroscope and magnetometer. The MPU9250 chip, encapsulated on board, is responsible for capturing acceleration movement, magnetic measurements, and rotation movements, all of which have 3 reading axes. The module also has a BMP180 atmospheric pressure sensor. The board is driven with an input voltage from 2.5 V to 3.6 V and consumption of 3.7 mA. Inertial measuring board, accelerometer and 9-axis gyroscope; (FIG. 2)

The accelerometer model supports configuration with values of +/−2, +/−4, +/−8, ou+/−16 g, the gyroscope variations of +/−250, +/−500, +/−1000, ou+/−2000 degrees/s and the magnetometer in full scale in the range of +/−4800 μT with 16-bit resolution.

To capture the environment brightness data, a LDR (Light dependent Resistor) sensor was used. Variable Resistor by Brightness (5 mm LDR). (FIG. 3).

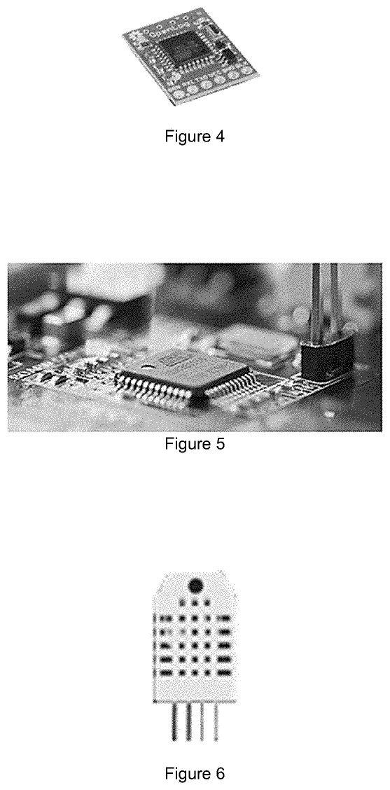

Data logger OpenLog of SparkFun. was used to store the collected data. It allows to record incoming serial data from 2400 to 115.200 bps and supports microSD cards up to 64 GB. SparkFun OpenLog (FIG. 4).

To control the sensors and process the collections, Arduino, an open-source platform of free hardware prototyping platform based on Atmel Corporation's ATmega microcontroller, was used.

Microcontroller is a small computer (SoC) in a single integrated circuit that contains a processor core, memory and programmable input/output peripherals and can be programmed. (FIG. 5)

The DHT22 sensor was used to measure humidity and air temperature. This sensor allows temperature readings from −40 to +80 degrees Celsius with accuracy of −0.5 degrees C. and humidity from 0 to 100% with accuracy of −2%. AM2302 DHT22 Humidity and Temperature sensor. (FIG. 6)

### Electrical Circuit Project

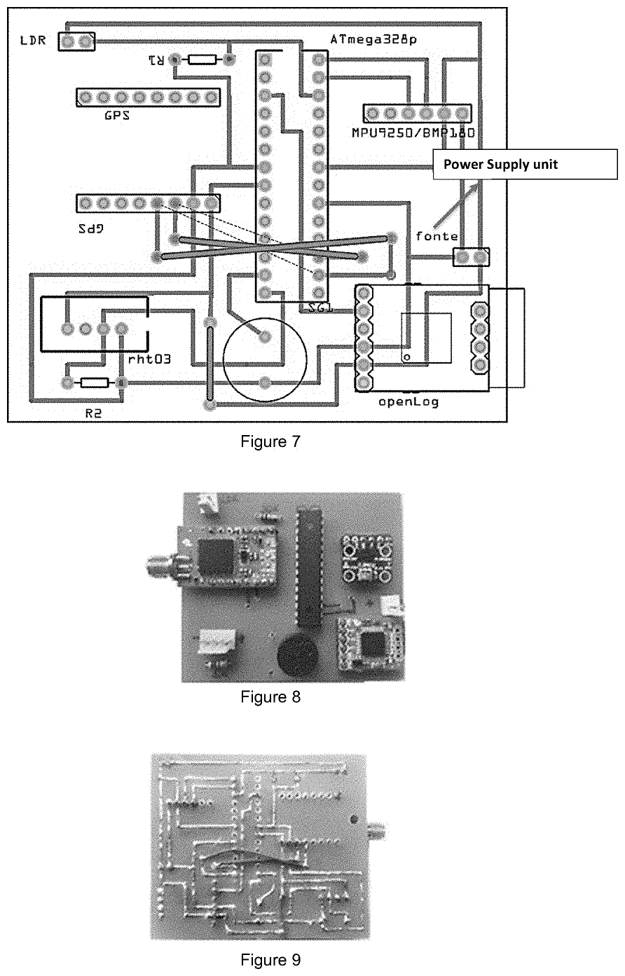

The circuit was planned and designed so that all the components would be on a single board. Fritzing1 software was used to organize the components layout on the board. FIG. 8 shows the proposed arrangement for the board, using the ATmega328p microcontroller as the central system, joining the GPS module, the motion sensor module (accelerometer, gyroscope, and magnetometer in a single component), the OpenLog module for writing data to the memory card, an LDR resistor for collecting light data and the humidity and air temperature sensor. FIG. 7 shows each of the necessary connections to interconnect the components in the proposed circuit. Circuit design developed at Fritzing. (FIG. 7).

The circuit was built on a phenolite board, which allows for the connection and welding of the components. The circuit is drawn on the board and the copper not corresponding to the circuit is corroded. This approach reduces the possibilities of connection problems. Female pins have been welded onto the top of the board, allowing the components to be fit together, allowing them to be removed quickly and easily. At the bottom the pin connections are interconnected by a copper track or with wires and weld (FIG. 9).

The built-in board facilitated the fitting of the sensors and eliminated the problems of poor contact, which usually happens in the work performed on protoboards. For the prototype this option was important because the sensors could be easily swapped. For a commercial solution, the sensors should be welded directly to the circuit board, ensuring that they do not become detached by handling the equipment. In the experiment, to prevent the sensors from becoming loose from the fittings, they were fixed to the push pins with hot-melt adhesive.

The circuit had its circuit reduced thanks to the use of only one microcontroller. In typical prototypes that use the Arduino platform, designers choose to use a full board, voltage controllers, input and output pins, oscillator crystal, and other electronic components that assist in the development phase, but are not used in more mature prototypes.

Therefore, the circuit board can only bring part of the Arduino prototyping platform, reducing the final size of the system. It can be concluded that the production of the board has a lower price than the board models sold, considering the cost of the components necessary for the construction/assembly of the board.

Another problem was programming to interconnect all the components in Arduino. The GPS receiver, motion sensors, and OpenLog module use serial communication for communication with Arduino. However, the ATmerga328p microcontroller has only one serial communication channel, causing these three components to compete for it. It was necessary to program the code so that the communication of one would not interfere with the communication of the other: what could happen is a component to start recording in the buffer while the other was still using it.

In the initial tests, with the sensors individually programmed, this problem did not appear, appearing when they were integrated. To ensure that sensor readings occur every 1 second (standard configuration of sensors used) the microcontroller reading and writing rate has been adjusted as fast as possible.

### Collar Structure

For the circuit to be placed in the animal, a leather belt, with a case attached, was used to store the circuit with the electronic components. The belt (FIG. 12/A) is about 130 cm×4 cm×0.5 cm (length×width×thickness) to ensure that it did not break in case it got stuck in something like a branch or fence. (FIG. 12)

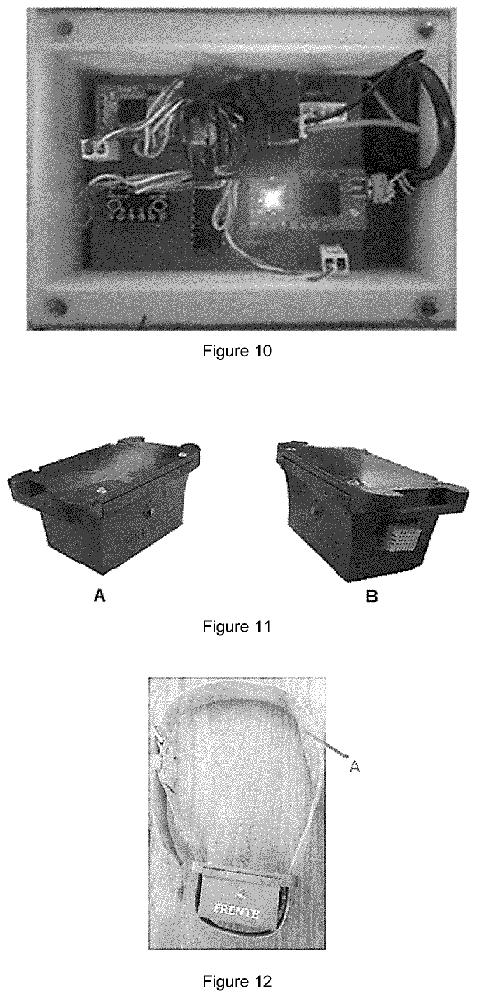

The circuit was placed in a case made of ABS plastic material, measuring 10 cm×7 cm×9 cm (width×height×depth) and a removable cover secured with screws and nuts to make the system robust and waterproof’. (FIG. 10).

### Assembly of the Collar Components

The LDR sensor was not inside the case. Two holes have been drilled in front of the case (FIG. 11/A) where the sensor has been fitted and welded to two wires which have been connected to the circuit. The air temperature and humidity sensor has also been installed on the outside of the plastic casing and is protected below the leather strap (FIG. 11/B).

What is claimed is:

1. ANIMAL'S BEHAVIOR COLLECTION, MONITORING AND ANALYSIS SYSTEM, characterized by being composed of a structure with collar and electronic components to generate information about the animals' behavior on pasture.

2. SYSTEM, according to claim 1, characterized by the structure with collar being composed of a leather belt, a coupled box of plastic material, to store the circuit with the electronics and removable cover attached with screws and nuts.

3. SYSTEM, according to claim 1, characterized by the belt having the measurements 130 cm×4 cm×0.5 cm (length×width×thickness) and the plastic-material-attached box has dimensions 10 cm×7 cm×9 cm (width×height×depth).

4. SYSTEM, according to claim 1, characterized by electronic components comprise:
a) GPS receiver module;
b) inertial measuring plate, accelerometer and 9-axis gyroscope;
c) atmospheric pressure sensor;
d) environment sensor;
e) humidity and air temperature sensor;
f) Sensors and processing microcontroller.

5. SYSTEM, according to claim 2, characterized by the belt having the measurements 130 cm×4 cm×0.5 cm (length×width×thickness) and the plastic-material-attached box has dimensions 10 cm×7 cm×9 cm (width×height×depth).
